(19) United States
(12) Patent Application Publication
(10) Pub. No.: US 2023/0051328 A1
(43) Pub. Date: Feb. 16, 2023

(54) CLOUD STORAGE ACCELERATION LAYER FOR ZONED NAMESPACE DRIVES

(71) Applicant: Intel Corporation, Santa Clara, CA (US)

(72) Inventors: Mariusz Barczak, Gdansk (PL); Wojciech Malikowski, Gdansk (PL); Mateusz Kozlowski, Gdansk (PL); Lukasz Lasek, Skarzysko Kamienna (PL); Artur Paszkiewicz, Gdansk (PL); Kapil Karkra, Chandler (PL)

(21) Appl. No.: 17/819,435

(22) Filed: Aug. 12, 2022

(51) Int. Cl. G06F 12/10

(52) U.S. Cl. CPC G06F 12/10; G06F 2212/651

(57) ABSTRACT

Systems, apparatuses, and methods provide for a memory controller to manage a tiered memory including a zoned namespace drive memory capacity tier. For example, a memory controller includes logic to translate a standard zoned namespace drive address associated with a user write to a tiered memory address write. The tiered memory address write is associated with the tiered memory including the persistent memory cache tier and the zoned namespace drive memory capacity tier. A plurality of tiered memory address writes are collected, where the plurality of tiered memory address writes include the tiered memory address write and other tiered memory address writes in the persistent memory cache tier. The collected plurality of tiered memory address writes are transferred from the persistent memory cache tier to the zoned namespace drive memory capacity tier, via an append-type zoned namespace drive write command.

### TECHNICAL FIELD

Embodiments generally relate to memory controllers. More particularly, embodiments relate to memory controllers to manage a tiered memory including a zoned namespace drive memory capacity tier.

### BACKGROUND

The trend of NAND storage devices is increasing density. For example, such increasing density may be addressed through higher capacity, bigger indirection units, and/or higher bits per NAND cell. Further, such increasing density typically result in bigger write amplification factor (WAF).

One downside of such increasing density NAND is lowering endurance and performance. As a result, performance of such drives can be comparable to hard disk drive (HDD) devices. This is especially manifested in cases of non-sequential workloads.

To mitigate such problem, the industry created zoned namespace drives (ZNS). Zoned namespace drives may require, however, sequential writes.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example computing system with a tiered memory for zoned namespace drives according to an embodiment;

FIG. 2 is an illustration of an example of a tiered memory for zoned namespace drives according to an embodiment;

FIG. 3 is a block diagram of another example of a tiered memory for zoned namespace drives according to an embodiment;

FIG. 4 is a chart 400 that shows the advantageous lowering of WAF according to an embodiment;

FIG. 5 is a chart of an example of a method of managing cache evictions according to an embodiment;

FIG. 6 is another chart of an example of a method of managing cache evictions according to an embodiment; and

FIG. 7 is an illustration of an example of a semiconductor package apparatus according to an embodiment.

### DESCRIPTION OF EMBODIMENTS

As discussed above, zoned namespace drives (ZNS) may require sequential writes. Such required sequential writes are extremely problematic because an application using such a device will need to force sequential write IO patterns.

Existing solutions are typically based on adapting each individual application through changes to the applications themselves (e.g., or application filesystem). However, such application based adaptations are typically repeated on an application-by-application basis. Additionally, such application based adaptations address only input/output (IO) pattern problems, but do not address a need to manage a write amplification factor (WAF) (e.g., where the actual number of physical writes to the storage media is an undesirable multiple of the logical amount or write requests) to increase drive lifetime. Further, such application based adaptations typically requires each application to handle an entire garbage collection procedure, so software may become very complicated.

As will be described in greater detail below, some implementations described herein utilize a storage translation layer between physical devices and a user logical space. The first device is high endurance and high-performance drive (e.g., Persistent Memory (PM), such as a crosspoint persistent memory (e.g., INTEL OPTANE) or the like), the second drive based on a zoned namespace drive (ZNS) capacity device. In such an example, the system uses a write-shaping buffer based on high-endurance and fast storage media (e.g., Persistent Memory (PM), such as a crosspoint persistent memory (e.g., INTEL OPTANE) or the like). Such a write-shaping buffer permits each write to be staged on the write-shaping buffer first and later moved to a NAND device in the background.

Such a storage translation layer maintains its own logical to physical blocks translation. Additionally, such a storage translation layer exposes to standard addressing method (e.g., by logical blocks) to applications being run on virtual machines; however, physical addressing by the storage translation layer can be non-standard (e.g., utilizing zoned namespace addressing or the like). Such internal mapping allows for the storage translation layer to translate and/or an improved performance.

Advantageously, some implementations described herein utilize a storage translation layer for ZNS to address following potential problems: avoiding redesign of applications to take advantages of ZNS, address the high write amplification factor (WAF) of NAND devices, and address the low endurance of high-density NAND devices. Such problems increases customer cost because they get lower performance and endurance.

More specifically, some implementations described herein reduce customer cost, improve memory performance, and/or increase memory longevity. For example, some implementations described herein result in significant WAF reduction, which leads to performance increases (e.g., IOPS, bandwidth, QoS, the like, and/or combinations thereof) and endurance improvement (e.g., longer NAND device lifetime). In another example, some implementations described herein permit workload locality and interception of hot data by such a write-shaping buffer. Further, some implementations described herein eliminate a need to write directly to the NAND device, which directly addresses issues with low high-density NAND devices having a low endurance. In a further example, some implementations described herein allow an application to use ZNS drives without any modification, where the application will operate using storage as usual while also leveraging ZNS drive advantages. Further, because of ZNS data placement capability, some implementations described herein implement tenant isolation to address the neighborhood noising problem, which advantageously minimizes WAF and maximizes memory endurance.

Systems, apparatuses, and methods described below provide for a memory controller to manage a tiered memory including a zoned namespace drive memory capacity tier. For example, a memory controller includes logic to translate a standard zoned namespace drive address associated with a user write to a tiered memory address write. The tiered memory address write is associated with the tiered memory including the persistent memory cache tier and the zoned namespace drive memory capacity tier. A plurality of tiered memory address writes are collected, where the plurality of tiered memory address writes include the tiered memory address write and other tiered memory address writes in the persistent memory cache tier. The collected plurality of tiered memory address writes are transferred from the persistent memory cache tier to the zoned namespace drive memory capacity tier, via an append-type zoned namespace drive write command.

As used herein the term “append” refers to an aggregated write command specific to zoned namespace drives (ZNS) (e.g., also referred to herein as an append-type zoned namespace drive write command).

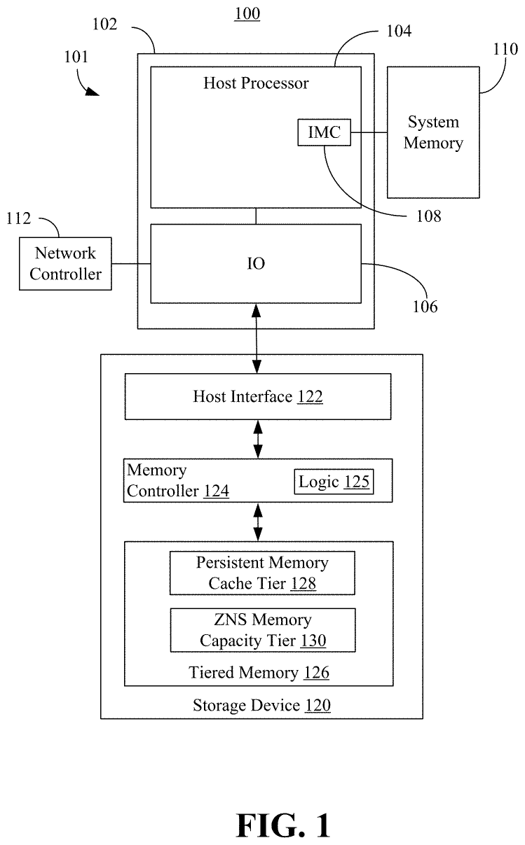

FIG. 1 is a block diagram of an example cloud computing system 100 with a tiered memory for zoned namespace drives according to an embodiment. In the illustrated example, a storage device 120 (e.g., including a solid state drive (SSD)) is in communication with a host 101.

The illustrated cloud computing system 100 also includes a system on chip (SoC) 102 having a host processor 104 (e.g., central processing unit/CPU) and an input/output (IO) module 106. The host processor 104 typically includes an integrated memory controller (IMC) 108 that communicates with system memory 110 (e.g., dynamic random access memory/DRAM). The illustrated IO module 106 is coupled to the storage device 120 as well as other system components such as a network controller 112.

In some implementations, the storage device 120 is shared by a plurality of users that provides tenant service (e.g., with Bandwidth (BW) and/or Quality of Service (QoS) requirements). The storage device 120 includes a host interface 122, a memory controller 124 that includes a storage acceleration layer logic 125, and a tiered memory 126 that includes a plurality of memory dies.

In the illustrated example, the tiered memory 126 includes a persistent memory cache tier 128 and a zoned namespace drive memory capacity tier 130. In some implementations the persistent memory cache tier 128 has a first endurance level and a first performance speed that are both higher than a second endurance level and a second performance speed of the zoned namespace drive memory capacity tier 130. In some examples, the persistent memory cache tier 128 is a crosspoint persistent memory or the like and the zoned namespace drive memory capacity tier 130 is a NAND memory or the like.

In some implementations described herein, the zoned namespace drive memory capacity tier 130 is implemented as a high-density NAND (e.g., like quad-level cell (QLC) memory that supports ZNS interface).

In some implementations described herein, the persistent memory cache tier 128 is implementable as a transistor-less persistent memory, such as a transistor-less stackable cross point architecture persistent memory or the like. Such transistor-less persistent memory is a byte addressable write-in-place nonvolatile memory that has memory cells (e.g., sitting at the intersection of word lines and bit lines) distributed across a plurality of storage dies and individually addressable, and in which bit storage is based on a change in bulk resistance and the like. In some implementations, such persistent memory includes single-level cell (SLC) memory, MLC (two level), TLC (three level), quad-level cell (QLC) memory, PLC (five level in development), three-dimensional (3D) crosspoint memory, INTEL OPTANE three-dimensional (3D) crosspoint memory, the like, and/or combinations thereof.

In operation, implementations described herein may be implemented in one or more memory devices. Such a memory device may include non-volatile memory (NVM) and/or volatile memory. Non-volatile memory is a storage medium that does not require power to maintain the state of data stored by the medium. In one embodiment, the memory structure is a block addressable storage device, such as those based on NAND or NOR technologies. A storage device may also include future generation nonvolatile devices, such as a three-dimensional (3D) crosspoint memory device, or other byte addressable write-in-place nonvolatile memory devices. In one embodiment, the storage device may be or may include memory devices that use silicon-oxide-nitride-oxide-silicon (SONOS) memory, electrically erasable programmable read-only memory (EEPROM), chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The term “storage device” may refer to the die itself and/or to a packaged memory product. In some embodiments, 3D crosspoint memory may comprise a transistor-less stackable cross point architecture (e.g., a transistor-less persistent memory structure) in which memory cells sit at the intersection of word lines and bit lines and are individually addressable and in which bit storage is based on a change in bulk resistance. In particular embodiments, a memory module with non-volatile memory may comply with one or more standards promulgated by the Joint Electron Device Engineering Council (JEDEC), such as JESD235, JESD218, JESD219, JESD220-1, JESD223B, JESD223-1, or other suitable standard (the JEDEC standards cited herein are available at jedec.org).

Volatile memory is a storage medium that requires power to maintain the state of data stored by the medium. Examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of the memory modules complies with a standard promulgated by JEDEC, such as JESD79F for Double Data Rate (DDR) SDRAM, JESD79-2F for DDR2 SDRAM, JESD79-3F for DDR3 SDRAM, or JESD79-4A for DDR4 SDRAM (these standards are available at jedec.org). Such standards (and similar standards) may be referred to as DDR-based standards and communication interfaces of the storage devices that implement such standards may be referred to as DDR-based interfaces.

As will be described in greater detail below, the memory controller 124 with the storage acceleration layer logic 125 is to translate a standard zoned namespace drive address associated with a user write to a tiered memory address write. The tiered memory address write is associated with the tiered memory including the persistent memory cache tier and the zoned namespace drive memory capacity tier. A plurality of tiered memory address writes are collected, where the plurality of tiered memory address writes include the tiered memory address write and other tiered memory address writes in the persistent memory cache tier. The collected plurality of tiered memory address writes are transferred from the persistent memory cache tier to the zoned namespace drive memory capacity tier, via an append-type zoned namespace drive write command.

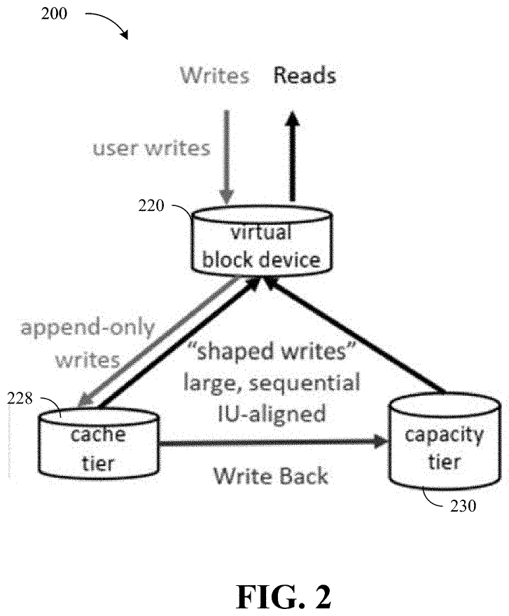

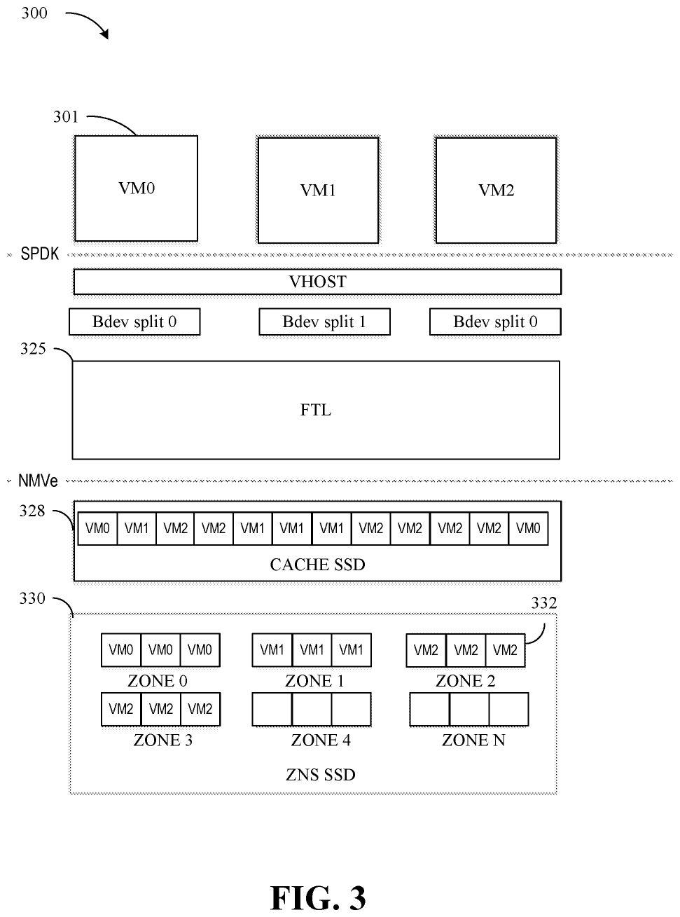

Additional and/or alternative operations for cloud computing system 100 are described in greater detail below in the description of FIGS. 2 and 3.

FIG. 2 is an illustration of an example of a tiered memory 200 for zoned namespace drives according to an embodiment. As illustrated, the tiered memory 200 includes a cache tier 228 and a capacity tier 230 in communication with a virtual block device 220 (e.g., as implemented via the memory controller 124 with the storage acceleration layer logic 125 of FIG. 1)

One goal of some implementations herein is to leverage unique ZNS drive capabilities via the capacity tier 230 in combination with a Persistent Memory (PM) via the cache tier 228 (e.g., a crosspoint persistent memory (e.g., INTEL OPTANE solid state drive (SSD)) or the like) in a transparent way for existing applications.

In some examples, a configuration is made with two block devices—the cache tier 228 and the capacity tier 230. For example, the cache tier 228 is a high performance, high endurance Persistent Memory (PM) (e.g., a crosspoint persistent memory (e.g., INTEL OPTANE solid state drive (SSD) or the like), and the capacity tier 230 could be high-density NAND (e.g., like quad-level cell (QLC) memory that supports ZNS interface). Some implementations herein combine those two devices and exposes a virtual block device to a host. The host advantageously performs IOs using a standard block interface.

In operation, in some implementations, such a ZNS drive is divided into zones with fixed size and with write access to single zone being sequential. Also, there is limitation of write queue depth equal to one to a single zone. To saturate a single zone, an append-type write command for ZNS drives allows a high queue depth to be generated for a single zone, while a logical address of such an append-type write command is provided in completion callback. Existing file systems and application are not compatible with such an append-type write command without modification to each file system and application. Some techniques described herein can advantageously use such an append-type write command in an efficient way.

Additional and/or alternative operations for the tiered memory 200 are described in greater detail below in the description of FIG. 3.

FIG. 3 is a block diagram of another example of a tiered memory 300 for zoned namespace drives according to an embodiment. As illustrated, a plurality of virtual machines 301 (also referred to herein as tenants, users, etc.) in communication with a storage acceleration layer logic 325 for a tiered memory. In the illustrated implementation, such a tiered memory includes a persistent memory cache tier 328 and a zoned namespace drive memory capacity tier 330.

In operation, in some implementations, host writes are aggregated in the tiered memory includes a persistent memory cache tier 328, which acts as an append-only write buffer. The storage acceleration layer logic 325 maintains a logical to the physical table (L2P) to track user blocks. Once the persistent memory cache tier 328 is going full, the storage acceleration layer logic 325 makes the decision to move a portion of data from the persistent memory cache tier 328 to the zoned namespace drive memory capacity tier 330 (e.g., a capacity tier device (e.g., ZNS)). At this point, data placement techniques are used to move data on capacity storage. Such a ZNS drive provides a physical separation of zones 332, and this allows movement of data with different lifetimes to different zones. When the number of free zones is getting lower there the application of a garbage collection (GC) mechanism is performed based on picking the least valid zones and moving valid data within them to new zones to clean up more space. Due to tenant isolation, as illustrated in FIG. 3, GC efficiency is advantageously improved and the overall WAF of such an implementation is lower.

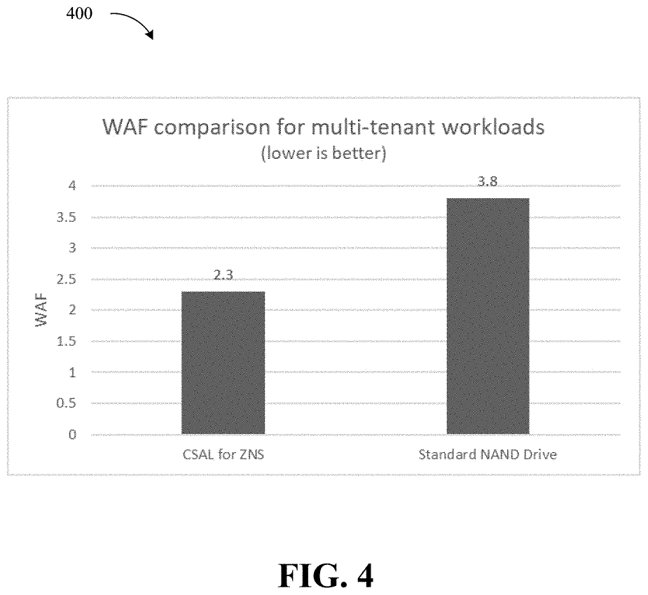

FIG. 4 illustrates a chart 400 that shows the advantageous lowering of WAF using the implementations described herein.

As illustrated, the cloud storage acceleration layer (CSAL) implementation tested is able to share/split the capacity between several independent tenants (e.g., a number of virtual machines). Conversely, mixing heterogonous workloads to one standard NAND drive in the baseline test causes WAF increase which results in user performance degradation, as well as QoS and SAL violations. Because the cloud storage acceleration layer (CSAL) implementation tested can separate those workloads, it prevents WAF increase. The following workload was tested.

TABLE 1
Tenant Description

1 write job: 4K/seq/qd128
1 write job1: 4K/rand/qd128
1 write job: 4K/zipf0.8/qd128
1 write job: 4K/zipf1.2/qd128

The results illustrated in chart 400 show the advantageous lowering of WAF using the implementations described herein.

Performance Results

In the bellow table there are presented performance results. The baseline below was run using QLC P5516 QLC 16 TB. The cloud storage acceleration layer (CSAL) implementation tested was configured to use two drives: OPTANE 5800 800 GB as a write buffer, and a QLC P5516 16 TB as a capacity storage. The value of the cloud storage acceleration layer (CSAL) implementation tested is demonstrated for random and locality workloads. For instance, the 4KiB random write workload got ˜20× gain as compared to the baseline. The measurements were executed for regular QLC drives. However, it is anticipated that even higher performance numbers when running with a ZNS-type capacity storage because the solution could utilize the additional ZNS drive space and generate even lower WAF.

TABLE 2

Bandwidth per job [MiB/s]

| Workload Description | QLC (10% OP) | CSAL |
|---|---|---|
| 8 write jobs: 64K/seq/qd128 | 390 | 359 |
| 8 write jobs: 64K/rand/qd128 | 60 | 101 |
| 8 write jobs: 4K/seq/qd128 | 5 | 365 |
| 8 write jobs: 4K/rand/qd128 | 3 | 63 |
| 8 write jobs: 64K/zipf0.8/qd128 | 60 | 126 |
| 8 write jobs: 64K/zipf1.2/qd128 | 60 | 487 |

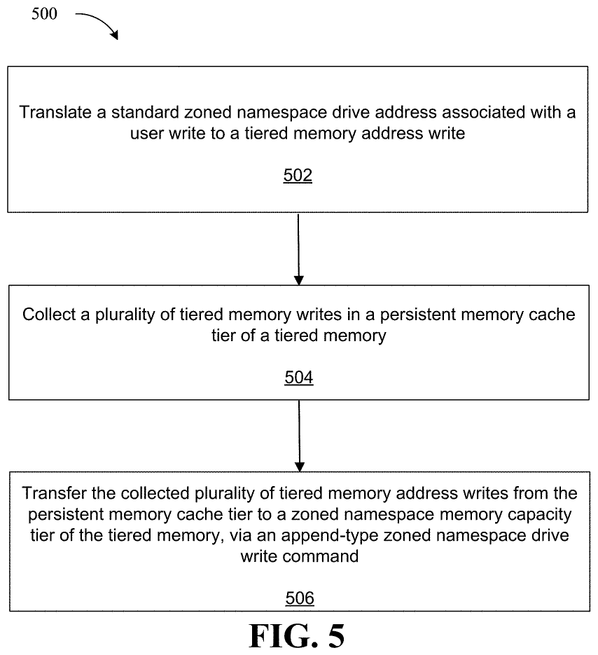

FIG. 5 is a chart of an example of a method 500 of manage a tiered memory including a zoned namespace drive memory capacity tier according to an embodiment. The method 500 may generally be implemented in a memory controller, such as, for example, the memory controller 124 with the storage acceleration layer logic 125 (e.g., see FIG. 1), already discussed.

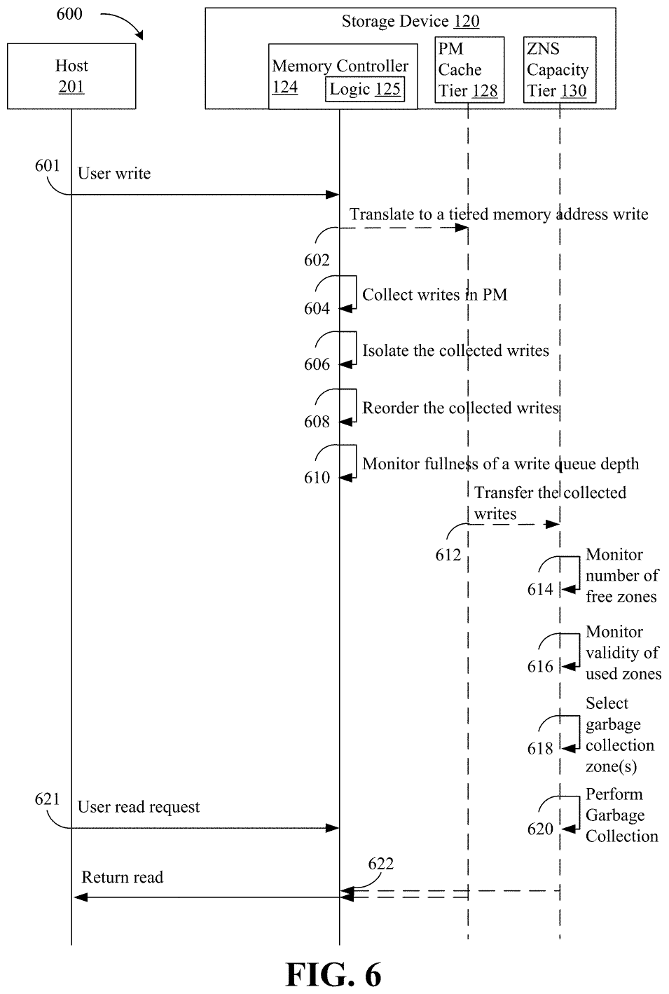

In an embodiment, the method 500 (and/or method 600 (FIG. 6)) may be implemented in logic instructions (e.g., software), configurable logic, fixed-functionality hardware logic, etc., or any combination thereof. While certain operations are illustrated in method 500, other portions have been intentionally left out to simplify the explanation of the method.

More particularly, the method 500 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

In some examples, the methods described herein (e.g., method 500 and/or method 600) may be performed at least in part by cloud processing.

It will be appreciated that some or all of the operations in method 500 (and/or method 600 (FIG. 6)) are described using a “pull” architecture (e.g., polling for new information followed by a corresponding response) may instead be implemented using a “push” architecture (e.g., sending such information when there is new information to report), and vice versa.

Illustrated processing block 502 provides for translating a standard zoned namespace drive address associated with a user write to a tiered memory address write. For example, the tiered memory address write is associated with a tiered memory including a persistent memory cache tier and a zoned namespace drive memory capacity tier.

Illustrated processing block 504 provides for collecting a plurality of tiered memory address writes. For example, the plurality of tiered memory address writes includes the tiered memory address write and other tiered memory address writes in the persistent memory cache tier.

Illustrated processing block 506 provides for transferring the collected plurality of tiered memory address writes from the persistent memory cache tier to the zoned namespace drive memory capacity tier, via an append-type zoned namespace drive write command.

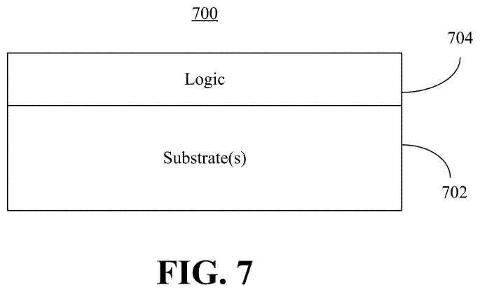

Additional and/or alternative operations for method 500 are described in greater detail below in the description of FIG. 6 and FIG. 7.

FIG. 6 is another chart of an example of a method 600 of manage a tiered memory including a zoned namespace drive memory capacity tier according to an embodiment. The method 600 may generally be implemented in a memory controller, such as, for example, the memory controller 124 with the storage acceleration layer logic 125 (e.g., see FIG. 1), already discussed.

Illustrated processing block 601 provides for receiving a user write.

Illustrated processing block 602 provides for translating a standard zoned namespace drive address associated with a user write to a tiered memory address write. For example, the tiered memory address write is associated with a tiered memory including a persistent memory cache tier and a zoned namespace drive memory capacity tier.

In some implementations the persistent memory cache tier has a first endurance level and a first performance speed that are both higher than a second endurance level and a second performance speed of the zoned namespace drive memory capacity tier.

In some examples, the persistent memory cache tier is a crosspoint persistent memory or the like and the zoned namespace drive memory capacity tier is a NAND memory or the like.

Illustrated processing block 604 provides for collecting a plurality of tiered memory address writes. For example, the plurality of tiered memory address writes includes the tiered memory address write and other tiered memory address writes in the persistent memory cache tier.

Illustrated processing block 606 provides for isolating the collected plurality of tiered memory address writes to one or more zones of the zoned namespace drive memory capacity tier. For example, such isolation may be performed on one or more of the following basis: a virtual machine-by-virtual machine basis, an application instance-by-application instance basis, a thread-by-thread basis, and/or the like.

Illustrated processing block 608 provides for reordering the collected plurality of tiered memory address writes to a sequential data order in response to an access pattern associated with an individual application. For example, the reorder of the collected plurality of tiered memory address writes is performed prior to the transfer from the persistent memory cache tier to the zoned namespace drive memory capacity tier.

Illustrated processing block 610 provides for monitoring a fullness of a write queue depth associated with the collected plurality of tiered memory address writes. For example, the write queue depth is equal to a single zone of the zoned namespace drive memory capacity tier.

Illustrated processing block 612 provides for transferring the collected plurality of tiered memory address writes from the persistent memory cache tier to the zoned namespace drive memory capacity tier, via an append-type zoned namespace drive write command.

For example, the transfer of the collected plurality of tiered memory address writes from the persistent memory cache tier to the zoned namespace drive memory capacity tier is done in response to the fullness of the write queue depth.

Illustrated processing block 614 provides for monitoring a number of free zones in the zoned namespace drive memory capacity tier.

Illustrated processing block 616 provides for monitoring a validity of utilized zones in the zoned namespace drive memory capacity tier.

Illustrated processing block 618 provides for selecting a garbage collection zone in response to the monitored validity of the utilized zones.

Illustrated processing block 620 provides for performing garbage collection in response to the monitored number of free zones in the zoned namespace drive memory capacity tier.

Illustrated processing block 621 provides for receiving a user read request.

Illustrated processing block 622 provides for transferring data from both the persistent memory cache tier and the zoned namespace drive memory capacity tier in response to a user read request.

Additional and/or alternative operations for method 600 are described in greater detail below in the description of FIG. 7.

FIG. 7 shows a semiconductor apparatus 700 (e.g., chip and/or package). The illustrated apparatus 700 includes one or more substrates 702 (e.g., silicon, sapphire, gallium arsenide) and logic 704 (e.g., transistor array and other integrated circuit/IC components) coupled to the substrate(s) 702. In an embodiment, the logic 704 implements one or more aspects of the method 500 (FIG. 5) and/or the method 600 (FIG. 6), already discussed.

In some implementations, when operated as a controller, the logic 704 is to translate a standard zoned namespace drive address associated with a user write to a tiered memory address write. The tiered memory address write is associated with the tiered memory including the persistent memory cache tier and the zoned namespace drive memory capacity tier. A plurality of tiered memory address writes are collected, where the plurality of tiered memory address writes include the tiered memory address write and other tiered memory address writes in the persistent memory cache tier. The collected plurality of tiered memory address writes are transferred from the persistent memory cache tier to the zoned namespace drive memory capacity tier, via an append-type zoned namespace drive write command.

In one example, the logic 704 includes transistor channel regions that are positioned (e.g., embedded) within the substrate(s) 702. Thus, the interface between the logic 704 and the substrate 702 may not be an abrupt junction. The logic 704 may also be considered to include an epitaxial layer that is grown on an initial wafer of the substrate 702.

### Additional Notes and Examples

Example 1 includes a storage device comprising a tiered memory including a persistent memory cache tier and a zoned namespace drive memory capacity tier, and a memory controller coupled to the tiered memory, the memory controller to translate a standard zoned namespace drive address associated with a user write to a tiered memory address write, wherein the tiered memory address write is associated with the tiered memory including the persistent memory cache tier and the zoned namespace drive memory capacity tier, collect a plurality of tiered memory address writes including the tiered memory address write and other tiered memory address writes in the persistent memory cache tier, and transfer, via an append-type zoned namespace drive write command, the collected plurality of tiered memory address writes from the persistent memory cache tier to the zoned namespace drive memory capacity tier.

Example 2 includes the storage device of Example 1, the memory controller further to isolate the collected plurality of tiered memory address writes to one or more zones of the zoned namespace drive memory capacity tier on one or more of the following basis a virtual machine-by-virtual machine basis, an application instance-by-application instance basis, or a thread-by-thread basis.

Example 3 includes the storage device of any one of Examples 1 to 2, the memory controller further to reorder the collected plurality of tiered memory address writes to a sequential data order in response to an access pattern associated with an individual application, wherein the reorder of the collected plurality of tiered memory address writes is performed prior to the transfer from the persistent memory cache tier to the zoned namespace drive memory capacity tier.

Example 4 includes the storage device of any one of Examples 1 to 3, the memory controller further to monitor a fullness of a write queue depth associated with the collected plurality of tiered memory address writes, wherein the write queue depth is equal to a single zone of the zoned namespace drive memory capacity tier, and in response to the fullness of the write queue depth, performing the transfer of the collected plurality of tiered memory address writes from the persistent memory cache tier to the zoned namespace drive memory capacity tier.

Example 5 includes the storage device of any one of Examples 1 to 4, the memory controller further to monitor a number of free zones in the zoned namespace drive memory capacity tier, and perform garbage collection in response to the monitored number of free zones in the zoned namespace drive memory capacity tier.

Example 6 includes the storage device of any one of Examples 1 to 5, the memory controller further to monitor a validity of utilized zones in the zoned namespace drive memory capacity tier, and select a garbage collection zone in response to the monitored validity of the utilized zones.

Example 7 includes the storage device of any one of Examples 1 to 6, the memory controller further to transfer data from both the persistent memory cache tier and the zoned namespace drive memory capacity tier in response to a user read request.

Example 8 includes the storage device of any one of Examples 1 to 7, wherein the persistent memory cache tier has a first endurance level and a first performance speed that are both higher than a second endurance level and a second performance speed of the zoned namespace drive memory capacity tier, and wherein the persistent memory cache tier is a crosspoint persistent memory and the zoned namespace drive memory capacity tier is a NAND memory.

Example 9 includes a semiconductor apparatus comprising one or more substrates, and logic coupled to the one or more substrates, wherein the logic is implemented at least partly in one or more of configurable or fixed-functionality hardware logic, the logic to translate a standard zoned namespace drive address associated with a user write to a tiered memory address write, wherein the tiered memory address write is associated with a tiered memory including a persistent memory cache tier and a zoned namespace drive memory capacity tier, collect a plurality of tiered memory address writes including the tiered memory address write and other tiered memory address writes in the persistent memory cache tier, and transfer, via an append-type zoned namespace drive write command, the collected plurality of tiered memory address writes from the persistent memory cache tier to the zoned namespace drive memory capacity tier.

Example 10 includes the semiconductor apparatus of Example 9, the logic further to isolate the collected plurality of tiered memory address writes to one or more zones of the zoned namespace drive memory capacity tier on one or more of the following basis a virtual machine-by-virtual machine basis, an application instance-by-application instance basis, or a thread-by-thread basis.

Example 11 includes the semiconductor apparatus of any one of Examples 9 to 10, the logic further to reorder the collected plurality of tiered memory address writes to a sequential data order in response to an access pattern associated with an individual application, wherein the reorder of the collected plurality of tiered memory address writes is performed prior to the transfer from the persistent memory cache tier to the zoned namespace drive memory capacity tier.

Example 12 includes the semiconductor apparatus of any one of Examples 9 to 11, the logic further to monitor a fullness of a write queue depth associated with the collected plurality of tiered memory address writes, wherein the write queue depth is equal to a single zone of the zoned namespace drive memory capacity tier, and in response to the fullness of the write queue depth, performing the transfer of the collected plurality of tiered memory address writes from the persistent memory cache tier to the zoned namespace drive memory capacity tier.

Example 13 includes the semiconductor apparatus of any one of Examples 9 to 12, the logic further to monitor a number of free zones in the zoned namespace drive memory capacity tier, and perform garbage collection in response to the monitored number of free zones in the zoned namespace drive memory capacity tier.

Example 14 includes the semiconductor apparatus of any one of Examples 9 to 13, the logic further to monitor a validity of utilized zones in the zoned namespace drive memory capacity tier, and select a garbage collection zone in response to the monitored validity of the utilized zones.

Example 15 includes at least one computer readable medium, comprising a set of instructions, which when executed by a computing device, cause the computing device to translate a standard zoned namespace drive address associated with a user write to a tiered memory address write, wherein the tiered memory address write is associated with a tiered memory including a persistent memory cache tier and a zoned namespace drive memory capacity tier, collect a plurality of tiered memory address writes including the tiered memory address write and other tiered memory address writes in the persistent memory cache tier, and transfer, via an append-type zoned namespace drive write command, the collected plurality of tiered memory address writes from the persistent memory cache tier to the zoned namespace drive memory capacity tier.

Example 16 includes the at least one computer readable medium of Example 15, wherein the set of instructions, which when executed by the computing device, cause the computing device further to isolate the collected plurality of tiered memory address writes to one or more zones of the zoned namespace drive memory capacity tier on one or more of the following basis a virtual machine-by-virtual machine basis, an application instance-by-application instance basis, or a thread-by-thread basis.

Example 17 includes the at least one computer readable medium of any one of Examples 15 to 16, wherein the set of instructions, which when executed by the computing device, cause the computing device further to reorder the collected plurality of tiered memory address writes to a sequential data order in response to an access pattern associated with an individual application, wherein the reorder of the collected plurality of tiered memory address writes is performed prior to the transfer from the persistent memory cache tier to the zoned namespace drive memory capacity tier.

Example 18 includes the at least one computer readable medium of any one of Examples 15 to 17, wherein the set of instructions, which when executed by the computing device, cause the computing device further to monitor a fullness of a write queue depth associated with the collected plurality of tiered memory address writes, wherein the write queue depth is equal to a single zone of the zoned namespace drive memory capacity tier, and in response to the fullness of the write queue depth, performing the transfer of the collected plurality of tiered memory address writes from the persistent memory cache tier to the zoned namespace drive memory capacity tier.

Example 19 includes the at least one computer readable medium of any one of Examples 15 to 18, wherein the set of instructions, which when executed by the computing device, cause the computing device further to monitor a number of free zones in the zoned namespace drive memory capacity tier, and perform garbage collection in response to the monitored number of free zones in the zoned namespace drive memory capacity tier.

Example 20 includes the at least one computer readable medium of any one of Examples 15 to 19, wherein the set of instructions, which when executed by the computing device, cause the computing device further to monitor a validity of utilized zones in the zoned namespace drive memory capacity tier, and select a garbage collection zone in response to the monitored validity of the utilized zones.

Example 21 includes a method, comprising translating a standard zoned namespace drive address associated with a user write to a tiered memory address write, wherein the tiered memory address write is associated with a tiered memory including a persistent memory cache tier and a zoned namespace drive memory capacity tier, collecting a plurality of tiered memory address writes including the tiered memory address write and other tiered memory address writes in the persistent memory cache tier, and transferring, via an append-type zoned namespace drive write command, the collected plurality of tiered memory address writes from the persistent memory cache tier to the zoned namespace drive memory capacity tier.

Example 22 includes the method of example 21, further comprising isolating the collected plurality of tiered memory address writes to one or more zones of the zoned namespace drive memory capacity tier on one or more of the following basis a virtual machine-by-virtual machine basis, an application instance-by-application instance basis, or a thread-by-thread basis.

Example 23 includes the method of any one of Examples 21 to 22, further comprising reordering the collected plurality of tiered memory address writes to a sequential data order in response to an access pattern associated with an individual application, wherein the reorder of the collected plurality of tiered memory address writes is performed prior to the transfer from the persistent memory cache tier to the zoned namespace drive memory capacity tier.

Example 24 includes the method of any one of Examples 21 to 23, further comprising monitoring a fullness of a write queue depth associated with the collected plurality of tiered memory address writes, wherein the write queue depth is equal to a single zone of the zoned namespace drive memory capacity tier, and in response to the fullness of the write queue depth, performing the transfer of the collected plurality of tiered memory address writes from the persistent memory cache tier to the zoned namespace drive memory capacity tier.

Example 25 includes the method of any one of Examples 21 to 24, further comprising monitoring a number of free zones in the zoned namespace drive memory capacity tier, and performing garbage collection in response to the monitored number of free zones in the zoned namespace drive memory capacity tier.

Example 26 includes the method of any one of Examples 21 to 25, further comprising monitoring a validity of utilized zones in the zoned namespace drive memory capacity tier, and selecting a garbage collection zone in response to the monitored validity of the utilized zones.

Example 27 includes an apparatus comprising means for performing the method of any one of Examples 21 to 26.

Example 28 includes a machine-readable storage including machine-readable instructions, which when executed, implement a method or realize an apparatus as claimed in any preceding claim.

Technology described herein may therefore provide a performance-enhanced computing platform to the extent that it may advantageously improve resource utilization. For example, as compared to existing methods, the technology described herein advantageously reduces customer cost, improves memory performance, and/or increases memory longevity. For example, some implementations described herein result in significant WAF reduction, which leads to performance increases (e.g., IOPS, bandwidth, QoS, the like, and/or combinations thereof) and endurance improvement (e.g., longer NAND device lifetime). In another example, some implementations described herein permit workload locality and interception of hot data by such a write-shaping buffer. Further, some implementations described herein eliminate a need to write directly to the NAND device, which directly addresses issues with low high-density NAND devices having a low endurance. In a further example, some implementations described herein allow an application to use ZNS drives without any modification, where the application will operate using storage as usual while also leveraging ZNS drive advantages. Further, because of ZNS data placement capability, some implementations described herein implement tenant isolation to address the neighborhood noising problem, which advantageously minimizes WAF and maximizes memory endurance.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical, or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A storage device comprising:
a tiered memory including a persistent memory cache tier and a zoned namespace drive memory capacity tier; and
a memory controller coupled to the tiered memory, the memory controller to:
translate a standard zoned namespace drive address associated with a user write to a tiered memory address write, wherein the tiered memory address write is associated with the tiered memory including the persistent memory cache tier and the zoned namespace drive memory capacity tier;
collect a plurality of tiered memory address writes including the tiered memory address write and other tiered memory address writes in the persistent memory cache tier; and
transfer, via an append-type zoned namespace drive write command, the collected plurality of tiered memory address writes from the persistent memory cache tier to the zoned namespace drive memory capacity tier.

2. The storage device of claim 1, the memory controller further to:
isolate the collected plurality of tiered memory address writes to one or more zones of the zoned namespace drive memory capacity tier on one or more of the following basis: a virtual machine-by-virtual machine basis, an application instance-by-application instance basis, or a thread-by-thread basis.

3. The storage device of claim 1, the memory controller further to:
reorder the collected plurality of tiered memory address writes to a sequential data order in response to an access pattern associated with an individual application, wherein the reorder of the collected plurality of tiered memory address writes is performed prior to the transfer from the persistent memory cache tier to the zoned namespace drive memory capacity tier.

4. The storage device of claim 1, the memory controller further to:
monitor a fullness of a write queue depth associated with the collected plurality of tiered memory address writes, wherein the write queue depth is equal to a single zone of the zoned namespace drive memory capacity tier; and
in response to the fullness of the write queue depth, performing the transfer of the collected plurality of tiered memory address writes from the persistent memory cache tier to the zoned namespace drive memory capacity tier.

5. The storage device of claim 1, the memory controller further to:
monitor a number of free zones in the zoned namespace drive memory capacity tier; and
perform garbage collection in response to the monitored number of free zones in the zoned namespace drive memory capacity tier.

6. The storage device of claim 1, the memory controller further to:
monitor a validity of utilized zones in the zoned namespace drive memory capacity tier; and
select a garbage collection zone in response to the monitored validity of the utilized zones.

7. The storage device of claim 1, the memory controller further to:
transfer data from both the persistent memory cache tier and the zoned namespace drive memory capacity tier in response to a user read request.

8. The storage device of claim 1, wherein the persistent memory cache tier has a first endurance level and a first performance speed that are both higher than a second endurance level and a second performance speed of the zoned namespace drive memory capacity tier, and wherein the persistent memory cache tier is a crosspoint persistent memory and the zoned namespace drive memory capacity tier is a NAND memory.

9. A semiconductor apparatus comprising:
one or more substrates; and
logic coupled to the one or more substrates, wherein the logic is implemented at least partly in one or more of configurable or fixed-functionality hardware logic, the logic to:
translate a standard zoned namespace drive address associated with a user write to a tiered memory address write, wherein the tiered memory address write is associated with a tiered memory including a persistent memory cache tier and a zoned namespace drive memory capacity tier;
collect a plurality of tiered memory address writes including the tiered memory address write and other tiered memory address writes in the persistent memory cache tier; and
transfer, via an append-type zoned namespace drive write command, the collected plurality of tiered memory address writes from the persistent memory cache tier to the zoned namespace drive memory capacity tier.

10. The semiconductor apparatus of claim 9, the logic further to:
isolate the collected plurality of tiered memory address writes to one or more zones of the zoned namespace drive memory capacity tier on one or more of the following basis: a virtual machine-by-virtual machine basis, an application instance-by-application instance basis, or a thread-by-thread basis.

11. The semiconductor apparatus of claim 9, the logic further to:
reorder the collected plurality of tiered memory address writes to a sequential data order in response to an access pattern associated with an individual application, wherein the reorder of the collected plurality of tiered memory address writes is performed prior to the transfer from the persistent memory cache tier to the zoned namespace drive memory capacity tier.

12. The semiconductor apparatus of claim 9, the logic further to:
monitor a fullness of a write queue depth associated with the collected plurality of tiered memory address writes, wherein the write queue depth is equal to a single zone of the zoned namespace drive memory capacity tier; and
in response to the fullness of the write queue depth, performing the transfer of the collected plurality of tiered memory address writes from the persistent memory cache tier to the zoned namespace drive memory capacity tier.

13. The semiconductor apparatus of claim 9, the logic further to:
monitor a number of free zones in the zoned namespace drive memory capacity tier; and
perform garbage collection in response to the monitored number of free zones in the zoned namespace drive memory capacity tier.

14. The semiconductor apparatus of claim 9, the logic further to:
monitor a validity of utilized zones in the zoned namespace drive memory capacity tier; and
select a garbage collection zone in response to the monitored validity of the utilized zones.

15. At least one computer readable medium, comprising a set of instructions, which when executed by a computing device, cause the computing device to:
translate a standard zoned namespace drive address associated with a user write to a tiered memory address write, wherein the tiered memory address write is associated with a tiered memory including a persistent memory cache tier and a zoned namespace drive memory capacity tier;
collect a plurality of tiered memory address writes including the tiered memory address write and other tiered memory address writes in the persistent memory cache tier; and
transfer, via an append-type zoned namespace drive write command, the collected plurality of tiered memory address writes from the persistent memory cache tier to the zoned namespace drive memory capacity tier.

16. The at least one computer readable medium of claim 15, wherein the set of instructions, which when executed by the computing device, cause the computing device further to:
isolate the collected plurality of tiered memory address writes to one or more zones of the zoned namespace drive memory capacity tier on one or more of the following basis: a virtual machine-by-virtual machine basis, an application instance-by-application instance basis, or a thread-by-thread basis.

17. The at least one computer readable medium of claim 15, wherein the set of instructions, which when executed by the computing device, cause the computing device further to:
reorder the collected plurality of tiered memory address writes to a sequential data order in response to an access pattern associated with an individual application, wherein the reorder of the collected plurality of tiered memory address writes is performed prior to the transfer from the persistent memory cache tier to the zoned namespace drive memory capacity tier.

18. The at least one computer readable medium of claim 15, wherein the set of instructions, which when executed by the computing device, cause the computing device further to:
monitor a fullness of a write queue depth associated with the collected plurality of tiered memory address writes, wherein the write queue depth is equal to a single zone of the zoned namespace drive memory capacity tier; and
in response to the fullness of the write queue depth, performing the transfer of the collected plurality of tiered memory address writes from the persistent memory cache tier to the zoned namespace drive memory capacity tier.

19. The at least one computer readable medium of claim 15, wherein the set of instructions, which when executed by the computing device, cause the computing device further to:
monitor a number of free zones in the zoned namespace drive memory capacity tier; and
perform garbage collection in response to the monitored number of free zones in the zoned namespace drive memory capacity tier.

20. The at least one computer readable medium of claim 15, wherein the set of instructions, which when executed by the computing device, cause the computing device further to:
monitor a validity of utilized zones in the zoned namespace drive memory capacity tier; and
select a garbage collection zone in response to the monitored validity of the utilized zones.
